(19) United States
(12) Patent Application Publication
(10) Pub. No.: US 2022/0364931 A1
(43) Pub. Date: Nov. 17, 2022

(54) BOLOMETER AND METHOD FOR MANUFACTURING SAME

(71) Applicant: NEC Corporation, Tokyo (JP)

(72) Inventor: Mayumi KOSAKA, Tokyo (JP)

(73) Assignee: NEC Corporation, Tokyo (JP)

(21) Appl. No.: 17/731,784

(22) Filed: Apr. 28, 2022

(30) Foreign Application Priority Data
May 12, 2021 (JP) 2021-080853

(51) Int. Cl. G01J 5/20; C01B 32/174

(52) U.S. Cl. CPC G01J 5/20; C01B 32/174; G01J 2005/204

(57) ABSTRACT

An object of the present invention is to provide a method for manufacturing a microscopic bolometer film and a bolometer using the same via a simple method.

The present invention relates to a bolometer manufacturing method including: forming an interlayer having a function that enhances binding between a substrate and a semiconducting carbon nanotube, in a predetermined pattern shape on the substrate; and providing a droplet of a semiconducting carbon nanotube dispersion liquid on the formed interlayer.

This application is based upon and claims the benefit of priority from Japanese patent application No. 2021-080853, filed on May 12, 2021, the disclosure of which is incorporated herein in its entirety by reference.

### TECHNICAL FIELD

The present invention relates to a bolometer using carbon nanotubes and a method for manufacturing the same.

### BACKGROUND ART

As infrared sensors, quantum infrared sensors using HgCdTe as a material have been widely used; however, it is necessary to cool an element to a temperature that is equal to or lower than a temperature of liquid nitrogen, imposing a restriction in downsizing of the apparatus. Therefore, uncooled infrared sensors not requiring cooling of an element to a low temperature have recently attracted attention and bolometers that detect an electrical resistance change caused by a change in temperature of an element have been widely used.

For performance of a bolometer, a rate of electrical resistance change for temperature change, which is called TCR (temperature coefficient of resistance), and a resistivity are particularly important. As an absolute value of the TCR is larger, a temperature resolution of the infrared sensor becomes smaller and the sensitivity is thus enhanced. Also, for noise reduction, the resistivity needs to be lowered.

Conventionally, as an uncooled bolometer, a vanadium oxide thin film is used; however, because of a vanadium oxide thin film having a small TCR (approximately −2.0%/K), enhancement in TCR has been widely studied. For TCR enhancement, a material having semiconducting properties and a large carrier density is needed, and thus, application of semiconducting single-walled carbon nanotubes to a bolometer is expected.

Patent Literature 1 proposes bolometer fabrication having a thin film process of employing normal single-walled carbon nanotubes for a bolometer portion, in which a dispersed liquid resulting from single-walled carbon nanotubes being mixed in an organic solvent is cast onto electrodes and the single-walled carbon nanotubes is subjected to annealing treatment in the air.

Patent Literature 2 proposes bolometer fabrication in which, because metal and semiconducting components are mixed in a single-walled carbon nanotube, semiconducting single-walled carbon nanotubes are extracted using an ionic surfactant and employed for a bolometer portion.

### CITATION LIST

### Patent Literature

Patent Literature 1: International Publication No. WO2012/049801

Patent Literature 2: Japanese Patent No. 6455910

### SUMMARY OF INVENTION

### Technical Problem

However, in the carbon nanotube thin film used for the infrared sensor described in Patent Literature 1, since metallic carbon nanotubes are present in a mixed state in carbon nanotubes, TCR is low, and the improvement of the performance of the infrared sensor is limited. In addition, the infrared sensor using semiconducting carbon nanotubes described in Patent Literature 2 has a problem in that the ionic surfactant for separation cannot be easily removed.

The present invention has been made in view of the above circumstances and an object of the present invention is to provide a method for manufacturing a microscopic bolometer film and a bolometer using the same via a simple method.

### Solution to Problem

In order to solve the aforementioned problems, the present invention has the following features.

One aspect of the present invention relates to a bolometer manufacturing method comprising

forming an interlayer having a function that enhances binding between a substrate and a semiconducting carbon nanotube, in a predetermined pattern shape on the substrate, and

providing a droplet of a semiconducting carbon nanotube dispersion liquid on the formed interlayer.

### Advantageous Effect of Invention

According to the present invention, a microscopic bolometer film and a bolometer using the same can be provided in a simple method.

### BRIEF DESCRIPTION OF DRAWINGS

FIG. 1 is a sectional schematic view of a bolometer portion.

FIG. 2A is a schematic diagram of forming a line-shape APTES film on a substrate.

FIG. 2B is a schematic diagram showing an example of a positional relationship between an electrode pair and a carbon nanotube film.

FIG. 3 is an example in which a CNT film is formed on an APTES applied line, and arranged to a line of electrode pairs.

FIG. 4 is an SEM image of an edge portion of a line-shape.

FIG. 5 is an example in which a line-shape is arranged to a line of electrode pairs.

FIG. 6 is an example in which two edges of a line-shape is arranged to different lines of electrode pairs.

FIG. 7 is a schematic diagram of forming an APTES film in a quadrangular shape on a substrate.

FIG. 8 is a schematic diagram of a carbon nanotube aligned film formed on a quadrangular shape APTES film, and electrodes arranged on the aligned film.

FIG. 9 is a schematic diagram of forming a circular shape APTES film on a substrate.

FIG. 10 is an example in which a circular shape APTES film is arranged to electrodes.

FIG. 11 is an example in which a circular shape APTES film is applied to two different lines of electrode pairs.

FIG. 12 is an example in which lines of electrodes are arranged on the facing arcs of a circular shape, and intermediate position thereof.

FIG. 13 is an example of an array in which three lines of electrode pairs are arranged on a circular shape.

FIG. 14 is an example of an array in which three lines of electrode pairs are arranged on a circular shape.

FIG. 15 is an example in which electrodes are arranged on a quadrangular shape portion at which an APTES applied line and a carbon nanotube applied line cross perpendicular to each other.

### DESCRIPTION OF EMBODIMENTS

The invention of the present application has the features described above, and the embodiments will be explained below. Although the embodiments described below have technically preferred limitations for carrying out the invention, the scope of the invention is not limited to the following.

A bolometer manufacturing method of the present invention includes: forming an interlayer having a function that enhances binding between a substrate and a carbon nanotube in a predetermined pattern shape on the substrate (patterning); and providing a carbon nanotube dispersion liquid on the formed interlayer to form a carbon nanotube film having a desired shape on the interlayer.

More specifically, an interlayer having a function that enhances binding between a substrate and carbon nanotubes is formed on the substrate in such a manner that at least a part of the interlayer approximately perpendicularly bridges the first electrode and the second electrode. Or, an interlayer is formed in such a manner that an edge of a part where the interlayer is formed approximately perpendicularly bridges the first electrode and the second electrode. Then, a carbon nanotube dispersion liquid is dripped on the part where the interlayer is formed, and then a dispersion medium is removed and/or the substrate is dried.

Such manufacturing method enables manufacturing a microscopic bolometer film and a bolometer using the same via a simple method.

Also, in an embodiment, a carbon nanotube layer can be downsized, enabling downsizing of a bolometer element.

Furthermore, the manufacturing method of the present embodiment also has advantages of high mass productivity and low cost.

In the present embodiment, a shape of the interlayer having a function that enhances binding between the substrate and the carbon nanotube may be, for example, a line shape, a quadrangular shape or a circular shape.

As the line shape, in a bolometer in which a first electrode and a second electrode each have a substantially rectangular shape and long sides thereof are disposed substantially in parallel with each other, a shape extending in a direction approximately perpendicular or approximately parallel to the long sides of the electrodes can be exemplified.

The quadrangular shape can be a quadrangular shape, at least one side of which being approximately parallel to electrical current flowing between the first electrode and the second electrode. Also, the shape may be a dash line shape in which a plurality of quadrangles are arranged in a direction approximately parallel to the electrical current (that is, a direction approximately perpendicular to the long sides of the electrodes).

The circular shape may be any shape as long as a part of a circular arc bridges the first electrode and the second electrode, and examples of a shape of the circle include an exact circular shape, an elliptical shape, an oval shape and a nearly circular shape.

These shapes of the interlayer will be described in more detail in the later-described embodiments.

In the present invention, the interlayer is not specifically limited as long as the interlayer is a layer made of a material that enhances binding between the substrate and the carbon nanotube.

It is preferable that a material of the interlayer be a compound having both a moiety that binds or adheres to a surface of the substrate and a moiety that binds or adheres to the carbon nanotube. Consequently, the interlayer functions as a medium serving to bind the substrate and the carbon nanotube. Here, for binding between the substrate and the interlayer, and binding between the interlayer and the carbon nanotube, not only chemical binding but also various intermolecular interactions such as electrostatic interaction, surface adsorption, hydrophobic interaction, van der Waals' force, hydrogen bonding can be used.

Also, it is preferable that the material of the interlayer be a compound that increases a lyophilic property of the surface of the substrate. Treatment using such compound enables a droplet of the carbon nanotube dispersion liquid to be provided and held only on the part in which the interlayer is formed. Consequently, it is possible to easily control a shape and a size of the carbon nanotube film by patterning of the interlayer.

Also, in an embodiment, the carbon nanotube can easily be aligned at a desired position by patterning the interlayer into a predetermined shape.

Also, in an embodiment, a density, a film thickness, a degree of alignment, etc., of the carbon nanotube film can be made more uniform by patterning the interlayer into a predetermined shape.

Examples of the moiety that binds or adheres to the surface of the substrate in the material of the interlayer include alkoxysilyl group (SiOR), SiOH, hydrophobic moiety, hydrophobic group, and the like. Examples of hydrophobic moiety and hydrophobic group include methylene group (methylene chain) and alkyl group each having a carbon number of 1 or more, preferably 2 or more, and preferably 20 or less, more preferably 10 or less, and the like.

Examples of the moiety that binds or adheres to the carbon nanotube in the material of the interlayer include amino groups such as primary amino group (—NH₂), secondary amino group (—NHR₁) or tertiary amino group (—NR₁R₂), ammonium group (—NH₄), imino group (═NH), imide group (—C(═O)—NH—C(═O)—), amide group (—C(═O)NH—), epoxy group, isocyanurate group, isocyanate group, ureide group, sulfide group, mercapto group, and the like.

The material of the interlayer is not specifically limited but examples thereof include a silane coupling agent. A silane coupling agent includes both a reactive group that binds to or interacts with an inorganic material and a reactive group that binds to or interacts with an organic material in a molecule, and serves to bind the organic material and the inorganic material. In the present embodiment, the carbon nanotube can be fixed on the substrate by forming a single-layer multimolecular film presenting a reactive group that binds to the carbon nanotube on the substrate using, for example, a silane coupling agent including both a reactive group that binds to a substrate such as an Si substrate and a reactive group that binds to a carbon nanotube.

Examples of the silane coupling agent include:

silane coupling agents (aminosilane compounds) each including amino group and alkoxysilyl group such as 3-aminopropyltrimethoxysilane, 3-aminopropylmethyltriethoxysilane, 3-aminopropylmethyltrimethoxysilane, 3-aminopropyltriethoxysilane (APTES), 3-(2-aminoethyl)aminopropyltrimethoxysilane, N-(2-aminoethyl)-3-aminopropyltrimethoxysilane, N-2-(aminoethyl)-3-aminopropylmethyltrimethoxysilane and N-(2-aminoethyl)-3-aminopropylmethyldimethoxysilane;

silane coupling agents each including epoxy group and alkoxysilyl group such as 3-glycidoxypropyltrimethoxysilane, 3-glycidoxypropyltriethoxysilane, 3-glycidoxypropylmethyldimethoxysilane, 3-glycidoxypropylmethyldiethoxysilane, 2-(3,4-epoxycyclohexyl)ethyltrimethoxysilane, 3-glycidoxypropyldiethoxysilane and triethoxy(3-glycidyloxypropyl)silane;

isocyanurate-based silane coupling agents such as tris-(trimethoxysilylpropyl)isocyanurate;

ureide-based silane coupling agents such as 3-ureidepropyltrialkoxysilane;

mercapto-based silane coupling agents such as 3-mercaptopropylmethyldimethoxysilane, 3-mercaptopropyltrimethoxysilane and 3-mercaptopropyltriethoxysilane;

sulfide-based silane coupling agents such as bis(triethoxysilylpropyl)tetrasulfide; and

isocyanate-based silane coupling agents such as 3-isocyanatepropyltriethoxysilane.

Particularly, a silane coupling agent including amino group (aminosilane compound) is preferable because of good binding to carbon nanotubes.

Other examples of the material of the interlayer include polymers each including a moiety that can bind or adhere to a substrate such as a plastic substrate and a reactive group that binds to a carbon nanotube, for example, a cation polymer.

Examples of such polymers include poly(N-methylvinylamine), polyvinylamine, polyallylamine, polyallyldimethylamine, polydiallylmethylamine, polydiallyldimethylammonium chloride, polydiallyldimethylammonium trifluoromethanesulfonate, polydiallyldimethylammonium nitrate, polydiallyldimethylammonium perchlorate, polyvinylpyridinium chloride, poly(2-vinylpyridine), poly(4-vinylpyridine), polyvinyl imidazole, poly(4-aminomethylstyrene), poly(4-aminostyrene), polyvinyl(acrylamide-co-dimethylaminopropylacrylamide), polyvinyl(acrylamide-co-dimethylaminoethylmethacrylate), polyethylenimine (PEI), DAB-Am and polyamideamine dendrimer, polyaminoamide, polyhexamethylene biguanide, polydimethylamine-epichlorohydrin, a product of alkylation of polyethylenimine by methyl chloride, a product of alkylation of polyaminoamide by epichlorohydrin, cationic polyacrylamide using a cationic monomer, a formalin condensate of dicyandiamide, dicyandiamide, polyalkylenepolyamine polycondensate, natural cationic polymers (for example, partially deacetylated chitin, chitosan and chitosan salt), synthetic polypeptides (for example, polyasparagine, polylysine, polyglutamine and polyarginine).

Among such polymers, a cation polymer including amino group and hydrophobic group or hydrophobic moiety is preferable from the perspective of fixing carbon nanotubes to the substrate.

Use of such polymer enables forming an interlayer presenting a plurality of reactive groups that bind or adhere to carbon nanotubes on a substrate. Such interlayer is not specifically limited but can have a thickness of 5 nm to 10 μm, preferably 10 nm to 1 μm from the perspective of uniform adherence.

The material of the interlayer can appropriately be selected in consideration of the material of the substrate to be used. Here, a material forming the substrate may be an inorganic material or an organic material and any of those used in the relevant technical field can be used with no specific limitation. The inorganic material is not limited but examples thereof include, e.g., glass, Si, SiO₂, SiN and the like. The organic material is not limited but examples thereof include, e.g., plastic, rubber and the like, for example, polyimide, polyethylene, polypropylene, polystyrene, polyvinyl chloride, polyethylene terephthalate, acrylonitrile styrene resin, acrylonitrile butadiene styrene resin, fluororesin, methacryl resin, polycarbonate and the like, and in an embodiment, a material used for a flexible substrate is preferable.

Examples of embodiments of the present invention will be described in detail below. In each of the below examples, an example in which an APTES layer or a polylysine layer is used as an interlayer and an Si substrate or a plastic substrate is used as a substrate will be described; however, the interlayer and the substrate are not limited to these layers or substrates.

Also, in a bolometer manufacturing method, processes other than a process of forming a carbon nanotube layer on a substrate are not limited to those described below by example, and those used in the relevant technical field can be used with no specific limitation.

In the present specification, the term “approximately perpendicular” encompasses perfect perpendicularity, and deviations within a range of 30° or less, preferably 20° or less, for example, 10° or less from the perfect perpendicularity. The term “approximately parallel” encompasses perfect parallelism and deviations within a range of 30° or less, preferably 20° or less, for example, 10° or less from the perfect parallelism. Also, it is preferable that “approximately perpendicular” and “approximately parallel” include not only a case where a side intersecting a target (for example, an electrode) is a straight line but also a case where a side intersecting a target (for example, an electrode) is a part of a circular arc, and in such case, it is preferable that a tangent to the circular arc be within the above range.

Also, terms such as “APTES adhering portion”, “APTES applied portion” and “APTES portion” are synonymous and mean a region in which an interlayer is formed using APTES.

Also, terms such as “carbon nanotube layer” and “carbon nanotube film” can be used synonymously. Also, “carbon nanotube aligned film” or “networked carbon nanotube film” may simply be referred to as, e.g., “carbon nanotube layer” or “carbon nanotube film”.

Also, a bolometer according to the present embodiment can also be used for detection of electromagnetic wave having a wavelength of, for example, 0.7 μm to 1 mm, for example, terahertz wave in addition to infrared light. In an embodiment, the bolometer is an infrared sensor. Also, the bolometer manufacturing method of the present embodiment can suitably be applied to manufacture of a bolometer array.

### First Embodiment

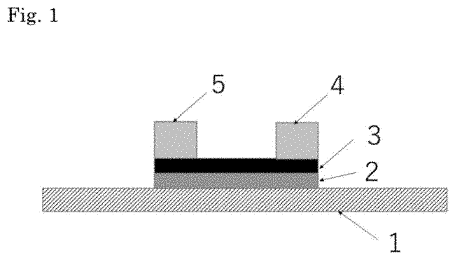

FIG. 1 illustrates a schematic sectional view of a bolometer portion according to an embodiment of the present invention. An APTES layer 2 is provided on an Si substrate 1, a carbon nanotube layer 3, a first electrode 4 and a second electrode 5 are provided thereon, and the electrode 4 and the electrode 5 are connected via the carbon nanotube layer 3 located therebetween. The disposition of the APTES layer 2, the carbon nanotube layer 3 and the electrodes 4, 5 on the substrate 1 is not limited to the disposition illustrated in FIG. 1 but the electrode 4 and the electrode 5 may be disposed on the APTES layer 2 or may directly be disposed on the Si substrate 1. Also, as long as the carbon nanotube layer 3 is at least partly provided on the APTES layer 2 and connects the electrode 4 and the electrode 5, the carbon nanotube layer 3 may be provided above or below the electrodes. As described later, this carbon nanotube layer 3 mainly consists of a plurality of semiconducting carbon nanotubes separated using a non-ionic surfactant.

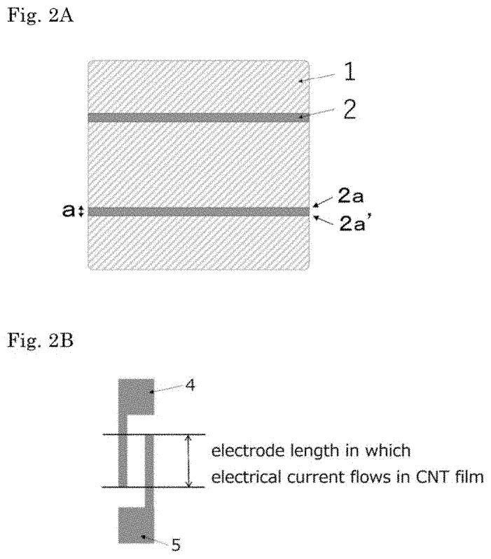

FIG. 2 (upper diagram) illustrates a schematic plan view of an APTES layer 2 according to an embodiment of the present invention, the APTES layer 2 being formed in a line-shape pattern. A substrate Si coated with SiO₂ is sequentially washed with acetone, isopropyl alcohol and water and subjected to oxygen plasma treatment to remove organic substances on a surface. Parts, other than line-shape APTES portions in FIG. 2A (upper diagram), of the Si substrate are masked, and then, the substrate is immersed in an APTES aqueous solution, or an APTES aqueous solution is sprayed onto the substrate, and the substrate is washed with water and dried. Subsequently, the masking is removed from the substrate. The line-shape APTES portions may be subjected to application using, e.g., a dispenser, an inkjet or a printer, and as necessary, washed with water and dried. A concentration of the APTES solution is not specifically limited, but, for example, is preferably 0.001% by volume or more and 30% by volume or less, more preferably 0.01% by volume or more and 10% by volume or less, still more preferably 0.05% by volume or more and 5% by volume or less. Also, a solvent for APTES is water or is not specifically limited as long as the solvent is one that allows the compound to dissolve and can easily be removed after being applied to the substrate.

Note that if a compound other than APTES is used as an interlayer, these concentration and solvent may arbitrarily be changed according to the compound used.

A width a of the line shape is desirably 10 μm to 1 cm, preferably 20 μm to 1 mm, more preferably 30 μm to 500 μm. For downsizing, 100 μm or less may be preferable. Also, in order to maximize an area in which electrical current flows via the carbon nanotube film, it is preferable that the width of the line shape be equal to or larger than an electrode length of a part in which the region of a pair of electrodes facing each other corresponds to a minimum device length. For example, in the case of a parallel electrode pair, an electrode length of a part in which the region of a pair of electrodes facing each other corresponds to a minimum device length is a length of a part in which the electrodes face each other in parallel. In the parallel electrode pair illustrated in FIG. 2B (lower diagram), the length described as “electrode length in which electrical current flows in CNT film” in the figure corresponds to the electrode length.

For the masking of parts except the line shapes, if the substrate is immersed in an APTES aqueous solution, for example, a tape such as a kapton tape or a masking tape, an adhesive sheet, or a mask material such as a resist can be used. If an APTES aqueous solution is sprayed to a substrate, a metal mask or a stencil mask that is in contact with the substrate can be used.

Upon a semiconducting carbon nanotube dispersion liquid resulting from dispersion in an aqueous solution of polyoxyethylene alkyl ether such as polyoxyethylene (100) stearyl ether or polyoxyethylene (23) lauryl ether, which is a non-ionic surfactant, being dripped onto the line-shape APTES adhering portions 2, the parts to which no APTES adheres (masked parts) repel the dispersion liquid but the carbon nanotube dispersion liquid is rested on the APTES adhering portions 2 in the form of droplets.

With the droplets of the carbon nanotube dispersion liquid rested on the APTES adhering portions 2 formed on the substrate, the substrate is left at rest for, for example, one minute or more but 24 hours or less and then the droplets are washed out with alcohol such as ethanol or isopropyl alcohol or water, and the substrate is dried, carbon nanotubes adhere to the APTES adhering portions and a carbon nanotube film is thus fabricated. It is also possible to control an amount of carbon nanotubes adhering, via the time of the substrate being left at rest, and the carbon nanotubes adhering to the APTES applied portions uniformly adhere in a networked form.

In this way, making carbon nanotubes adhere to an APTES adhering portion having a predetermined shape to form a networked carbon nanotube layer enables manufacturing a highly uniform carbon nanotube layer, and a bolometer comprising such carbon nanotube layer via a simple method.

The thickness of the carbon nanotube layer is not limited, for example, preferably 1 nm or more, more preferably 2 nm or more, and even more preferably 5 nm or more, and preferably less than 1 μm, more preferably 500 nm or less, and even more preferably 200 nm or less.

The carbon nanotube layer comprises semiconducting carbon nanotubes preferably in a ratio of 90% by mass or more, more preferably 95% by mass or more, and in some cases even more preferably 98% by mass or more, of the total carbon nanotubes. For the production of such carbon nanotube layers, it is desirable to use a dispersion liquid with a high concentration of semiconducting carbon nanotubes, which is obtained by separating metallic carbon nanotubes and semiconducting carbon nanotubes using, for example, the electric field-induced layer formation method.

The diameter of the carbon nanotubes is desirably 0.6 to 1.5 nm, preferably 0.6 to 1.2 nm, and more preferably 0.6 to 1.0 nm. The length of the carbon nanotubes is preferably in the range of 100 nm to 5 μm for easy dispersion and easy droplet formation. From the perspective of the conductivity of carbon nanotubes, a length of 100 nm or more is preferred, and from the perspective of less aggregation, a length of 5 μm or less is preferred. More preferably, the length is 500 nm to 3 μm, even more preferably 700 nm to 1.5 μm. It is preferred that at least 70% (number) of the carbon nanotubes have a diameter and a length in the above range.

When the diameter and the length of the carbon nanotubes are within the above range, the effect of semiconducting property becomes greater when semiconducting carbon nanotubes are used, and a large current value can be obtained, so that a high TCR value is easily obtained when used in a bolometer.

The carbon nanotube dispersion liquid used in the manufacturing method according to the present embodiment is described below.

The carbon nanotube dispersion liquid comprises the above-described carbon nanotubes. The concentration and the amount of droplet may be appropriately selected depending on the density and thickness and the like of the carbon nanotube layer to be formed. The concentration of carbon nanotubes in the dispersion liquid is not particularly limited but may be, for example, 0.0003 wt % or more, preferably 0.001 wt % or more, more preferably 0.003 wt % or more, and 10 wt % or less, preferably 3 wt % or less, more preferably 0.3 wt % or less.

The carbon nanotube dispersion liquid preferably comprises a surfactant in addition to carbon nanotubes. The surfactant in the carbon nanotube dispersion liquid is preferably a non-ionic surfactant. Unlike ionic surfactants, non-ionic surfactants have a weaker interaction with carbon nanotubes, and can be easily removed after the dispersion liquid is provided on the substrate. Therefore, stable carbon nanotube conductive paths can be formed and an excellent TCR value can be obtained. Non-ionic surfactants with longer molecular lengths are also preferred as they increase the distance between carbon nanotubes when providing the dispersion liquid on the substrate and carbon nanotubes are less likely to re-aggregate after water evaporation, thus the network state can be maintained.

When carbon nanotubes form a network, more contact points between carbon nanotubes are formed and more conductive paths are formed, resulting in lower resistance. In addition, in a network state, the probability of the slightly contained metallic carbon nanotubes connecting with each other to connect between electrodes is low, and consequently, the effect of semiconducting property becomes larger, and a larger resistance change for a temperature change (high TCR) can be achieved.

Furthermore, when a carbon nanotube film is formed on the entire surface of the substrate, there is a problem that a local agglomeration of carbon nanotubes is likely to occur during forming the carbon nanotube film, resulting in non-uniform density and thickness. On the other hand, APTES patterning produces carbon nanotube networks only at the patterning points, and as a result, the carbon nanotube density, the film thickness and the like can easily be controlled, and more uniform films can be produced.

Non-ionic surfactants can be appropriately selected, and it is preferable to use a non-ionic surfactant with a polyethylene glycol structure, typified by polyoxyethylene alkyl ether-based ones, singly or in combination.

The solvent of the carbon nanotube dispersion liquid is not limited as long as the carbon nanotubes can preferably be suspended in a dispersion, and includes, for example, water, heavy water, organic solvents or mixtures thereof, with water being preferred.

As the methods of separating and preparing a carbon nanotube dispersion liquid with a high proportion of semiconducting carbon nanotubes, and non-ionic surfactants used in said methods, methods described in WO 2020/158455, for example, can be used, and the document is incorporated herein by reference.

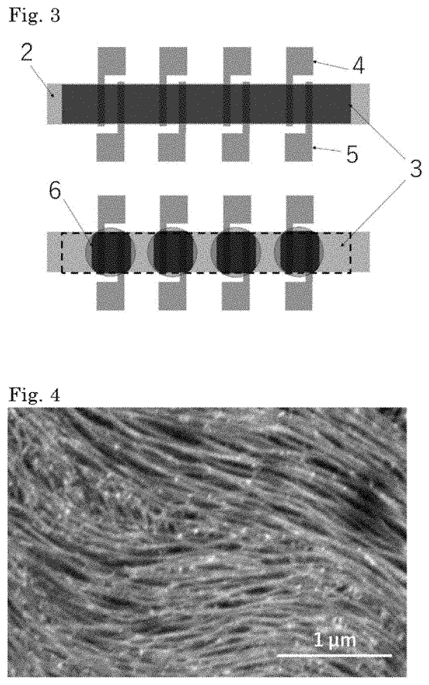

A bolometer of the present embodiment can be manufactured, for example, as follows after a line shape film of semiconducting carbon nanotubes as above is formed on a substrate. Since carbon nanotubes adhere only onto an APTES line, the film is formed in a single line shape. As in FIG. 3, a first electrode and a second electrode are formed so as to overlap on the film of carbon nanotubes via, e.g., gold vapor deposition. At this time, the electrodes are disposed in such a manner that long sides of the carbon nanotube film and the direction of electrical current flowing between each pair of the first electrode and the corresponding second electrode are approximately parallel with each other.

The material of the electrode is not limited as long as it has conductivity, and gold, platinum, titanium, and the like may be used singly or in combination. The method for producing the electrode is not particularly limited, and examples thereof include vapor deposition, sputtering, and printing method. The thickness may be appropriately adjusted and is preferably 10 nm to 1 mm, and more preferably 50 nm to 1 μm.

In the bolometer of the present embodiment, the distance between the first electrode and the second electrode is preferably 1 μm to 500 μm, and more preferably 5 μm to 300 μm. For miniaturization, it is more preferably 1 μm to 200 μm. When the distance between electrodes is 1 μm or more, a reduction in the nature of TCR can be suppressed, even in the case of containing a small amount of metallic carbon nanotubes. In addition, the distance between electrodes of 100 μm or less, for example, 50 μm or less is advantageous when the bolometer is applied to an image sensor by two-dimensionally arraying. The length of the first electrode 4 and the second electrode 5 is preferably short as long as carbon nanotubes can connect the both electrodes and electrically connect them, the part connecting to carbon nanotubes of 100 μm or less, for examples 50 μm or less is advantageous when the bolometer is applied to an image sensor by two-dimensionally arraying.

When carbon nanotubes are connected also to an adjacent electrode pair because the carbon nanotube film is in a line shape (extending across a plurality of electrode pairs) (upper row in FIG. 3), for example, unnecessary carbon nanotubes are removed via the following method. An acrylic resin solution such as a polymethylmethacrylate resin (PMMA) is applied to regions 6 each including an area between electrodes on the formed carbon nanotube film 3 to form a protective layer 6 of PMMA (lower row in FIG. 3). The substrate is heated at 200° C. in the atmosphere, extra solvent, impurities, etc., are removed and then the entire substrate is subjected to oxygen plasma treatment to remove extra carbon nanotubes, etc., present in regions, other than the regions 6 covered by the PMMA layer, of the carbon nanotube layer 3.

A protective layer may be provided on the surface of the carbon nanotube layer, if necessary. When the bolometer is used as an infrared sensor, the protective layer is preferably a material with high transparency in the infrared wavelength range to be detected, and acrylic resins such as PMMA, epoxy resins, Teflon (R) and the like may be used.

Although the above embodiment indicates a bolometer element fabrication method having a sequence of forming an APTES layer on an Si substrate and forming a carbon nanotube layer and then forming electrodes, a fabrication method in which the sequence is changed as follows may be employed. First, a first electrode and a second electrode are fabricated on a washed Si substrate via gold vapor deposition, and APTES is applied thereon. For the APTES application, parts other than the line shape portion are masked, and then the substrate is immersed in an APTES aqueous solution or an APTES aqueous solution is sprayed onto the substrate and the substrate is dried. Subsequently, the masking is removed. The line-shape APTES portion may be applied using, e.g., a dispenser, an inkjet or a printer, and as necessary, washed with water and dried.

Although the APTES layer is an insulating film, the APTES layer binds to a surface of a silicon dioxide film of the substrate and presents amino group on the surface, and thus, does not adhere to the gold electrode portions. A carbon nanotube dispersion liquid is dripped thereon and the substrate is left at rest, and then a dispersion medium of the dispersion liquid is washed out using, e.g., alcohol or water and the substrate is dried, and then, carbon nanotubes adhere to the APTES layer in a networked manner, and opposite ends of the formed carbon nanotube film are directly connected to the electrodes. When the carbon nanotubes are connected between a pair of adjacent electrodes, unnecessary carbon nanotubes present between the electrode pairs may be removed via, e.g., oxygen plasma treatment according to a method that is similar to the above.

For steps other than the steps of patterning APTES applied portion and forming a carbon nanotube layer on the APTES layer, the components, the material and the manufacturing processes and the like described in the present embodiment can appropriately be applied also to the below embodiments.

### Second Embodiment

FIG. 1 illustrates a schematic sectional view of a bolometer portion according to an embodiment of the present invention. An APTES layer 2 is provided on an Si substrate 1, a carbon nanotube layer 3, a first electrode 4 and a second electrode 5 are provided thereon, and the electrode 4 and the electrode 5 are connected via the carbon nanotube layer 3 located therebetween. The disposition of the APTES layer 2, the carbon nanotube layer 3 and the electrodes 4, 5 on the substrate 1 is not limited to the disposition illustrated in FIG. 1 but the electrode 4 and the electrode 5 may be disposed on the APTES layer 2, or may directly be disposed on the Si substrate 1. Also, as long as the carbon nanotube layer 3 is at least partly provided on the APTES layer 2 and connects the electrode 4 and the electrode 5, the carbon nanotube layer 3 may be provided above or below the electrodes. As described later, this carbon nanotube layer 3 mainly consists of a plurality of semiconducting carbon nanotubes separated using a non-ionic surfactant.

FIG. 2A (upper diagram) illustrates a schematic plan view of an APTES layer 2 according to an embodiment of the present invention, the APTES layer 2 being formed in a line-shape pattern. A substrate Si coated with SiO₂ is sequentially washed with acetone, isopropyl alcohol and water and subjected to oxygen plasma treatment to remove organic substances on a surface. Parts, other than line-shape APTES portions in FIG. 2A (upper diagram), of the Si substrate are masked, and then, the substrate is immersed in an APTES aqueous solution, or an APTES aqueous solution is sprayed onto the substrate, and the substrate is washed with water and dried. Subsequently, the masking is removed from the substrate. The line-shape APTES portions may be subjected to application using, e.g., a dispenser, an inkjet or a printer, and as necessary, washed with water and dried. The APTES aqueous solution may be prepared in a similar manner as described in the first embodiment.

The width a of the line shape is desirably 10 μm to 1 cm, preferably 20 μm to 1 mm, and more preferably 30 μm to 500 μm.

For the masking of parts except the line shape, if the substrate is immersed in an APTES aqueous solution, for example, a tape such as a kapton tape or a masking tape, an adhesive sheet, or a mask material such as a resist can be used. If an APTES aqueous solution is sprayed to a substrate, a metal mask or a stencil mask that is in contact with the substrate can be used.

Upon a semiconducting carbon nanotube dispersion liquid resulting from dispersion in an aqueous solution of polyoxyethylene alkyl ether such as polyoxyethylene (100) stearyl ether or polyoxyethylene (23) lauryl ether, which is a non-ionic surfactant, being dripped onto the line-shape APTES adhering portion 2, the parts to which no APTES adheres (masked parts) repel the dispersion liquid but the carbon nanotube dispersion liquid is rested on the APTES adhering portion 2 in the form of droplets. Next, the droplets are dried at edges of the APTES adhering portion 2. More specifically, when the substrate is put under conditions in which a solvent of the dispersion liquid can evaporate, water is gradually dried from the edge of the APTES line shape 2 because an evaporation rate is higher in the vicinity of an outer edge of a droplet than in the vicinity of a center of the droplet. At that time, the edge of the APTES line portion 2 serves to pin the contact line of the droplet, causing a capillary flow toward the edge to occur inside the droplet, and carbon nanotubes move outward from the center of the droplet, and the moved carbon nanotubes accumulate in the vicinities of edges 2a and 2a′ while being aligned approximately in parallel with the edges. Consequently, an aligned film of carbon nanotubes aligned approximately in parallel with electrical current flowing between the electrodes can be formed on each of edges of the interlayer applied portion. In the present specification, the term “aligned film” refers to a carbon nanotube aligned film formed by carbon nanotubes moving to the vicinity of an edge of a predetermined pattern shape via capillarity and being deposited while being aligned. The degree of alignment of carbon nanotubes in the present embodiment can be controlled by conditions such as a diameter and a length of the carbon nanotubes, a concentration of a surfactant and a drying rate, and by adjusting these conditions, a carbon nanotube film having a low degree of alignment or a networked film being little aligned can also be formed in the vicinities of the edges 2a and 2a′. In the present specification, descriptions relating the aligned film (for example, a positional relationship with electrodes, an element structure and arraying described later) can appropriately be applied also to such film having a low degree of alignment.

As described above, by aligning carbon nanotubes in the vicinity of an edge of an APTES adhering portion of a predetermined shape, a carbon nanotube layer with a high degree of alignment can be produced in a simple way.

This also enables the production of a bolometer with a high TCR value and low resistivity.

The degree of alignment of carbon nanotubes is defined in a plane FFT image obtained by performing two-dimensional fast Fourier transform on the SEM image of a carbon nanotube film and representing the distribution of unevenness in each direction by a frequency distribution, where a value obtained by integrating amplitudes of frequencies from −1 μm⁻¹ to +1 μm⁻¹ in one direction from the center is defined as an integrated value f, an integrated value in the direction x in which the integrated value f becomes maximum is defined as fx, an integrated value in the direction y vertical to the direction x is defined as fy, and the carbon nanotubes are defined as being aligned when fx/fy≥2. In the manufacturing method according to the present embodiment, a carbon nanotube film in which carbon nanotubes are not aligned with fx/fy=1 to 2 can be produced, and also, an aligned film of alignment carbon nanotubes with fx/fy≥2 can also be produced by adjusting the above mentioned manufacturing conditions. The SEM image which is the original image of the above FFT image needs to have visible unevenness for calculation by Fourier transform, and from the viewpoint of observing carbon nanotubes, the visual field range is preferably about 0.05 to 10 μm in vertical and horizontal directions.

This definition of alignment can be applied to the aligned film (or a film having a low degree of alignment) in the third to sixth embodiments described later.

The water contact angle between the substrate and the droplet can be from more than 0° and 90° or smaller, but is preferably more than 0° and 60° or smaller. The water contact angle can be obtained using the static method specified in JIS R3257; 1999. The water contact angle of a droplet can be controlled by the amount of the droplet relative to the area of the APTES applied portion.

In order to increase the degree of alignment, a temperature of the substrate at which the solvent of the dispersion liquid is evaporated is, for example, desirably 5° C. to 60° C., preferably 10° C. to 40° C. A relative humidity is preferably 15% RH to 80% RH.

Carbon nanotubes accumulated at an edge of an APTES applied portion are deposited in parallel with the edge as shown in the scanning electron microscope (SEM) image in FIG. 4. FIG. 4 is an SEM image of a part several micrometers on the center side from an edge of an APTES applied portion (the upper edge side of the image is the edge of the APTES applied portion) and shows that carbon nanotubes are aligned approximately in parallel with the edge.

The width to be deposited can be varied depending on, for example, the amount of dispersion liquid, the type and the concentration of carbon nanotubes in the dispersion liquid, the type and the concentration of surfactant, the diameter and the length of the carbon nanotubes, the substrate temperature and relative humidity, and the like, and a deposited layer of carbon nanotubes aligned 1 μm to 20 μm wide from an edge is desirable, more preferably 2 μm to 10 μm wide. The width of the carbon nanotube aligned film can be the average of measurements at arbitrary 10 points, measured by scanning electron microscopy or other means.

The thickness of the carbon nanotube layer is not limited, but is preferably 5 nm or more, more preferably 10 nm or more, more preferably 30 nm or more, and preferably 10 μm or less, more preferably 5 μm or less, and even more preferably 1 μm or less, preferably in the region from the edge of the APTES applied portion. The thickness of the carbon nanotubes can be measured using a laser microscope at arbitrary 10 points within 10 μm from the edge, and the thickness can be taken as the average value.

The carbon nanotube layer comprises semiconducting carbon nanotubes preferably in a ratio of 90% by mass or more, more preferably 95% by mass or more, and in some cases even more preferably 98% by mass or more, of the total carbon nanotubes. For the production of such carbon nanotube layers, it is desirable to use a dispersion liquid with a high concentration of semiconducting carbon nanotubes, which is obtained by separating metallic carbon nanotubes and semiconducting carbon nanotubes using, for example, the electric field-induced layer formation method.

The diameter of the carbon nanotubes is desirably 0.6 to 1.5 nm, preferably 0.6 to 1.2 nm, and more preferably 0.6 to 1.0 nm. The length of the carbon nanotubes is preferably in the range of 100 nm to 5 μm for easy dispersion and easy droplet formation. From the perspective of the conductivity of carbon nanotubes, a length of 100 nm or more is preferred, and from the perspective of less aggregation, a length of 5 μm or less is preferred. More preferably, the length is 500 nm to 3 μm, even more preferably 700 nm to 1.5 μm. It is preferred that at least 70% (number) of the carbon nanotubes have a diameter and a length in the above range.

When the diameter and the length of carbon nanotubes are within the above range, the effect of semiconducting property becomes greater when semiconducting carbon nanotubes are used, and a large current value can be obtained, so that a high TCR value is easily obtained when used in a bolometer.

The carbon nanotube dispersion liquid preferably comprises a surfactant in addition to the carbon nanotubes. When carbon nanotubes are deposited in the vicinity of an edge of an APTES applied portion in the manufacturing method according to the present embodiment, carbon nanotubes can be more easily aligned when the carbon nanotube dispersion liquid comprises a surfactant. The concentration of the surfactant in the dispersion liquid is not particularly limited, but for example, a critical micelle concentration or more to about 5% by mass or less is preferred, and 0.001% by mass or more to 3% by mass or less is more preferable, and 0.01% by mass or more to 1% by mass or less is particularly preferred. The surfactant in the carbon nanotube dispersion liquid is preferably a non-ionic surfactant. Non-ionic surfactants can be appropriately selected, and it is preferable to use a non-ionic surfactant with a polyethylene glycol structure, typified by polyoxyethylene alkyl ether-based ones, singly or in combination of two or more. Unlike ionic surfactants, non-ionic surfactants have a weaker interaction with carbon nanotubes, and can be easily removed after the dispersion liquid is provided on the substrate by washing with alcohol or water, or heating. Therefore, stable carbon nanotube conductive paths can be formed and an excellent TCR value can be obtained. Non-ionic surfactants with longer molecular lengths are also preferred as they increase the distance between carbon nanotubes when providing the dispersion liquid on the substrate and carbon nanotubes are less likely to re-aggregate after water evaporation, thus an aligned state can be maintained.

Aligned carbon nanotubes results in a lower resistance as the contact area between carbon nanotubes is increased and more conductive paths are formed. Consequently, a larger resistance change for a temperature change can be achieved (high TCR). On the other hand, also in a case where the carbon nanotubes moved toward the vicinity of the edge of a patterned shape are less aligned or formed in a network state, effect of increased density and film thickness of carbon nanotubes can be achieved. This allows the carbon nanotubes to form a dense network, which increases the number of contact points between carbon nanotubes and increases the number of conductive paths, thus achieving a lower resistance. In addition, the probability of the slightly contained metallic carbon nanotubes connecting with each other and connecting between electrodes is low, as a result, the effect of semiconducting property becomes larger, and a larger resistance change for a temperature change can be achieved.

In addition, in an embodiment using a non-ionic surfactant with a longer molecular length as the above-mentioned surfactant, re-aggregate of carbon nanotubes is suppressed and the network state can be maintained.

Furthermore, the manufacturing method of the present embodiment provides an advantage of enabling fabricating a highly uniform bolometer film by forming a carbon nanotube film at a predetermined position, that is, in the vicinity of an edge of a pattern shape using patterning of APTES and capillarity.

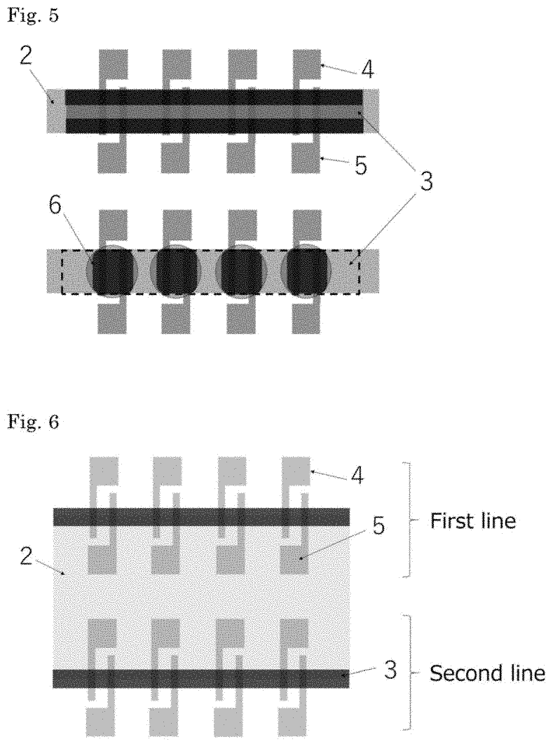

A bolometer of the present embodiment can be manufactured, for example, as follows after a line-shape aligned film of semiconducting carbon nanotubes as above is formed on a substrate. As shown in FIG. 5, the carbon nanotubes are deposited in the vicinities of opposite edges (2a, 2a′ in FIG. 2A (upper diagram)) of a line 2 in such a manner as to be aligned approximately in parallel with the edges, and thus, aligned films are fabricated in the shape of two parallel lines. First electrodes and second electrodes are produced so as to overlap on these aligned films of carbon nanotubes via, e.g., gold vapor deposition. At this time, the electrodes are installed in such a manner that the direction of alignment of carbon nanotubes and a direction of electrical current flowing between the first electrode and the corresponding second electrode are approximately parallel to each other.

In the bolometer of the present embodiment, the distance between the first electrode and the second electrode is preferably 1 μm to 500 μm, and more preferably 5 μm to 300 μm. For miniaturization, it is more preferably 1 μm to 200 μm. When the distance between the electrodes is 1 μm or more, a reduction in the nature of TCR can be suppressed, even in the case of containing a small amount of metallic carbon nanotubes. In addition, the distance between the electrodes of 100 μm or less, for example, 50 μm or less is advantageous when the bolometer is applied to an image sensor by two-dimensionally arraying. The length of the electrode 4 and the electrode 5 is preferably short as long as carbon nanotubes can connect the both electrodes, and electrically connect them, the part connecting to carbon nanotubes of 100 μm or less, for examples 50 μm or less is advantageous when the bolometer is applied to an image sensor by two-dimensionally arraying.

The electrodes are installed in such a manner as to be connected by two line-shape aligned films formed on opposite edges of an APTES applied portion, or are installed in such a manner as to be connected by either one line-shape aligned film. The electrodes being connected by two line-shape aligned films as shown in FIG. 5 (upper diagram) allows a resistance to be reduced by approximately half and thus is advantageous for reduction in resistance; however, a length of the electrodes needs to be longer than the width of a line shape of the APTES (width a in FIG. 2A (upper diagram)). On the other hand, as illustrated in FIG. 6, when the electrodes are connected by one line-shape aligned film alone, which is either one edge, the width of connection between the carbon nanotubes and the electrodes may be narrow, for example, 50 μm or less, which is advantageous for element downsizing such as two-dimensional arraying. Also, when APTES is applied in such a manner that a line shape width a of the APTES corresponds to an interval between elements as shown in FIG. 6, the two line-shape aligned films at opposite edges of the APTES can be used for two lines of elements and thus enables simple and easy arraying.

When carbon nanotubes are connected also to an adjacent electrode pair because the carbon nanotube aligned film is in a line shape (extending across a plurality of electrode pairs) (upper row in FIG. 5), for example, unnecessary carbon nanotubes are removed via the following method. An acrylic resin solution such as a polymethylmethacrylate resin (PMMA) is applied to regions 6 each including an area between electrodes on the formed aligned carbon nanotube film 3 to form protective layers 6 of PMMA (lower row in FIG. 5). The substrate is heated at 200° C. in the atmosphere, extra solvent, impurities, etc., are removed and then the entire substrate is subjected to oxygen plasma treatment to remove extra carbon nanotubes, etc., present in regions, other than the regions 6 covered by the PMMA layer, of the carbon nanotube layer 3.

A protective layer may be provided on the surface of the carbon nanotube layer, if necessary. When the bolometer is used as an infrared sensor, the protective layer is preferably a material with high transparency in the infrared wavelength range to be detected, and acrylic resins such as PMMA, epoxy resins, Teflon (R) and the like may be used.

Although the above embodiment indicates a bolometer element fabrication method having a sequence of forming an APTES layer on an Si substrate and forming a carbon nanotube layer and then forming electrodes, a fabrication method in which the sequence is changed as follows may be employed. First, a first electrode and a second electrode are fabricated on a washed Si substrate via gold vapor deposition, and APTES is applied thereon. For the APTES application, parts other than the line shape portion are masked, and then the substrate is immersed in an APTES aqueous solution or an APTES aqueous solution is sprayed onto the substrate, and the substrate is dried. Subsequently, the masking is removed. The line-shape APTES portion may be applied using, e.g., a dispenser, an inkjet or a printer, and as necessary, washed with water and dried.

Although the APTES layer is an insulating film, the APTES layer binds to a surface of a silicon dioxide film of the substrate and presents amino group on the surface, and thus, does not adhere to the gold electrode portions. A carbon nanotube dispersion liquid is dripped thereon and gradually dried, carbon nanotubes are deposited while being aligned to form an aligned film, and opposite ends of the formed aligned film are directly connected to the electrodes. When the carbon nanotubes are connected between adjacent electrode pairs, unnecessary carbon nanotubes present between the electrode pairs may be removed via, e.g., oxygen plasma treatment according to a method that is similar to the above.

In the following embodiments, other than the process of forming the carbon nanotube film, any component and manufacturing process of the bolometer described in the first or second embodiments above can be appropriately applied, unless otherwise stated.

### Third Embodiment

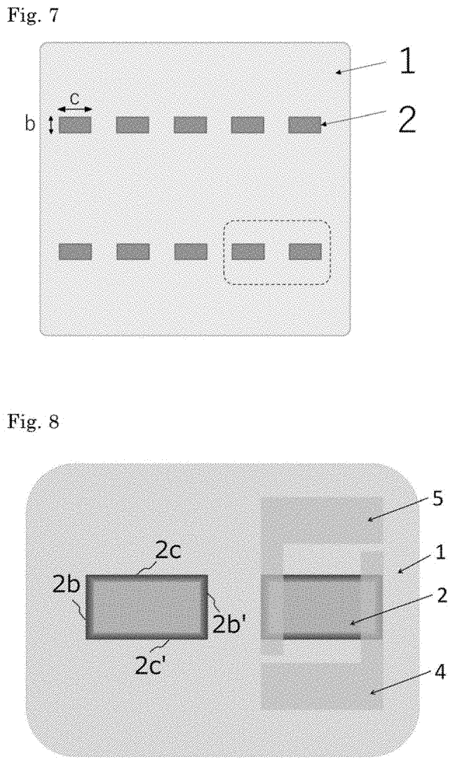

FIG. 7 illustrates a schematic plan view of an APTES layer 2 according to an embodiment of the present invention, the APTES layer 2 being formed in a quadrangle or a dash-line shape in which a plurality of quadrangles are arranged in a linear fashion. As in the first embodiment, parts, other than the quadrangular APTES portions in FIG. 7, of a washed Si substrate are masked, and then, the substrate is immersed in an APTES aqueous solution, or an APTES aqueous solution is sprayed onto the substrate, and the substrate is washed with water and dried. Subsequently, the masking is removed from the substrate. The quadrangular APTES portions may be subjected to application using, e.g., a dispenser, an inkjet or a printer and washed with water and dried.

A size of the quadrangular shape is such that a length (width b) of a side that is approximately parallel to a first electrode and a second electrode, which will be described later, is desirably 10 μm to 1 cm, preferably 20 μm to 1 mm, more preferably 30 μm to 300 μm. A length (width c) of a side that is approximately perpendicular to the electrodes is preferably 10 μm to 1 mm, more preferably 20 μm to 500 μm. Also, for downsizing, the length is more preferably 10 μm to 300 μm.

As in the first embodiment, a carbon nanotube dispersion liquid is dripped onto the quadrangular APTES adhering portion and left at rest and then washed with, e.g., alcohol or water and dried, and a carbon nanotube film with carbon nanotubes adhering in a networked fashion on the entire APTES adhering portion (networked film) can be produced. Patterning into a quadrangular shape enables forming a carbon nanotube film in which carbon nanotubes are more uniformly adhered thereto.

In addition, a carbon nanotube dispersion liquid is dripped on the quadrangular APTES adhering portion, and gradually dried in a similar manner as described in the second embodiment, carbon nanotubes are deposited on the edges of four sides of the quadrangular shape, while being aligned approximately in parallel to each side (aligned film). Depending on the conditions such as a diameter and a length of the carbon nanotubes, a concentration of a surfactant, and a drying rate, and the like, a carbon nanotube film having a low degree of alignment or a networked film being little aligned can also be formed in the vicinities of edges of four sides of the quadrangular shape. The descriptions regarding an aligned film described later can also be appropriately applied to these films having a low degree of alignment.

A bolometer of the present embodiment can be manufactured by forming such a quadrangular shape networked film or a quadrangular shape aligned film (aligned film formed in the vicinity of each of edges of four sides of a quadrangle) of semiconducting carbon nanotubes as above on a substrate and then disposing electrodes, for example, according to the shape of the carbon nanotube film formed. A case where a quadrangular shape aligned film is formed will be described in more detail by example. FIG. 8 illustrates the dash-line part in FIG. 7. As illustrated in FIG. 8, carbon nanotubes are deposited in an aligned manner on an edge of each of four sides, and thus, an aligned film is fabricated in the form of two sets of two parallel lines (that is, 2b/2b′ and 2c/2c′). A first electrode 4 and a second electrode 5 are fabricated on one set of aligned films (2b/2b′) of carbon nanotubes via gold vapor deposition. The two sets of aligned films are four sides of a quadrangle and thus are approximately perpendicular to each other, and if one set (2b/2b′) is located under the electrodes, the other set (2c/2c′) is approximately parallel to a direction of electrical current flowing between the first electrode 4 and the second electrode 5.

In the bolometer of the present embodiment, the distance between the first electrode and the second electrode is preferably 1 μm to 500 μm, and more preferably 5 μm to 300 μm. For miniaturization, it is more preferably 1 μm to 200 μm. When the distance between the electrodes is 1 μm or more, a reduction in the nature of TCR can be suppressed, even in the case of containing a small amount of metallic carbon nanotubes. In addition, the distance between electrodes of 100 μm or less, for example, 50 μm or less is advantageous when the bolometer is applied to an image sensor by two-dimensionally arraying.

In the case of carbon nanotube film in a network state (networked film), electrodes can be placed so that one networked film is connected to one pair of electrodes.

In the case of an aligned film, electrodes are installed in such a manner as to be connected by both of two line-shape aligned films, or are installed in such a manner as to be connected by either one line-shape aligned film. Electrodes being connected by two line-shape aligned films as in FIG. 8 allows a resistance to be reduced by approximately half and thus is advantageous for resistance reduction; however, a length of the electrodes needs to be longer than the width b of a quadrangle of APTES. On the other hand, when the electrodes are connected by one line-shape aligned film, which is either one edge, alone, the width of connection between the carbon nanotubes and the electrodes may be narrow, for example 50 μm or less, which is advantageous for element downsizing such as two-dimensional arraying.

In this embodiment, as shown in FIG. 7, since the networked film or an aligned film of carbon nanotubes is in a dash line shape, the electrodes can be installed such that the carbon nanotubes connect only between electrodes of each of the electrode pairs. In this case, no carbon nanotubes are present between adjacent electrode pairs, so a process to remove unnecessary carbon nanotubes is not needed. Heating at 200° C. in air can remove excess solvent, surfactants and other substances.

Also in the present embodiment, a protective layer may be provided on the surface of the carbon nanotube layer, if necessary. When the bolometer is used as an infrared sensor, the protective layer is preferably a material with high transparency in the infrared wavelength range to be detected, and acrylic resins such as PMMA, epoxy resins, Teflon (R) and the like may be used.

Although the above embodiment indicates a bolometer element fabrication method having a sequence of forming an APTES layer on an Si substrate and forming a carbon nanotube layer and then forming electrodes, a fabrication method in which the sequence is changed as follows may be employed. First, a first electrode and a second electrode are fabricated on a washed Si substrate via gold vapor deposition, and APTES is applied thereon. For the APTES application, the substrate is masked such that an APTES film of a quadrangle shape is formed between the electrodes of each of the electrode pairs, and APTES is not applied between the adjacent electrode pairs, and then the substrate is immersed in an APTES aqueous solution or an APTES aqueous solution is sprayed onto the substrate and the substrate is dried. Subsequently, the masking is removed. The quadrangle-shape APTES portions may be applied using, e.g., a dispenser, an inkjet or a printer, and as necessary, washed with water and dried. Although the APTES layer is an insulating film, the APTES layer binds to a surface of a silicon dioxide film of the substrate and presents amino group on the surface, and thus, does not adhere to the gold electrode portions. A carbon nanotube dispersion liquid is dripped thereon and the substrate is left at rest, washed out using, e.g., alcohol or water and dried, and then, carbon nanotubes adhere to the entire APTES applied portion in a networked manner. Or, when the dropped dispersion liquid is gradually dried, carbon nanotubes are deposited while being aligned on the edges of four sides of the APTES film. The opposite ends of the formed networked film or aligned film are directly connected to the electrodes. Since no carbon nanotube connects between adjacent electrode pairs, a process of removing unnecessary carbon nanotubes using PMMA and the like is not needed.

### Fourth Embodiment

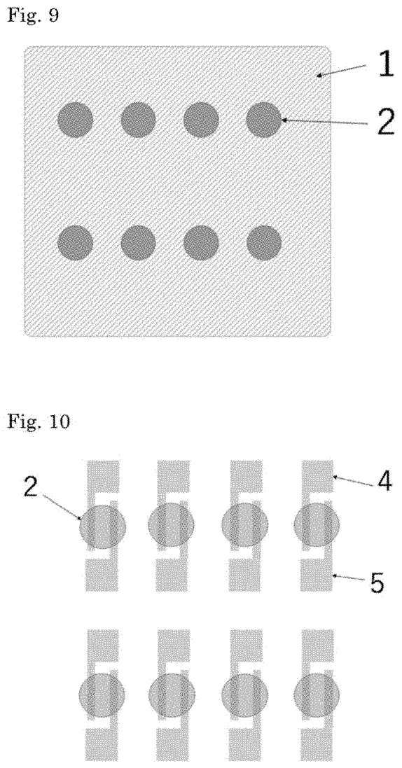

FIG. 9 illustrates a schematic plan view of an APTES layer 2 according to an embodiment of the present invention, the APTES layer 2 being formed in a circular shape. As in the first embodiment, parts, other than circular shape APTES portions in the figure, of a washed Si substrate are masked and then the substrate is immersed in an APTES aqueous solution or an APTES aqueous solution is sprayed onto the substrate and the substrate is washed with water and dried. Subsequently, the masking is removed from the substrate. The circular shape APTES portions may be subjected to application using, e.g., a dispenser, an inkjet or a printer and dried.

The size of the circular shape is desirably 10 μm to 1 cm in diameter, preferably 20 μm to 1 mm, and more preferably 30 μm to 500 μm. The shape of circular shape includes an exact circular shape, an oval shape, an elliptical shape, and a nearly circular shape.

As in the first embodiment, a carbon nanotube dispersion liquid is dripped onto the circular-shape APTES adhering portions and left at rest and then washed with, e.g., alcohol or water and dried, and a carbon nanotube film with carbon nanotubes adhering in a networked fashion on the entire APTES adhering portions (networked film) can be produced.

Also, as in the second embodiment, when a carbon nanotube dispersion liquid is dripped onto each of APTES adhering portions having a circular shape and gradually dried, carbon nanotubes are accumulated in an aligned manner on a circular circumference of the circular shape (aligned film). Also, depending on conditions such as a diameter and a length of the carbon nanotubes and a concentration of a surfactant, and a drying rate, a carbon nanotube film having a low degree of alignment, or in a networked state being little aligned can be formed in a doughnut-like line shape in the vicinity of an edge of the circular shape. The below aligned film-related descriptions can appropriately be applied also to such doughnut-like line shape film having a low degree of alignment.

A bolometer of the present embodiment can be manufactured by forming a circular shape networked film or a circular shape (doughnut-like line shape) aligned film of semiconducting carbon nanotubes on a substrate and then disposing electrodes according to the shape of the carbon nanotube film formed. For example, in the case of a circular shape (doughnut-like line shape) aligned film, carbon nanotubes are deposited in an aligned manner on an edge of a circle, the aligned film is fabricated in a doughnut-like line shape. A first electrode and a second electrode are fabricated so as to overlap on an arc of the circle of the carbon nanotube aligned film via gold vapor deposition. The circular arc is placed approximately parallel to the direction of electrical current flowing between the first electrode and the second electrode.

In the bolometer of the present embodiment, the distance between the first electrode and the second electrode is preferably 1 μm to 500 μm, and more preferably 10 μm to 300 μm. For miniaturization, it is more preferably 1 μm to 200 μm. When the distance between the electrodes is 1μm or more, a reduction in the nature of TCR can be suppressed, even in the case of containing a small amount of metallic carbon nanotubes. In addition, the distance between the electrodes of 100 μm or less, for example, 50 μm or less is advantageous when the bolometer is applied to an image sensor by two-dimensionally arraying. The length of the electrode 4 and the electrode 5 is preferably short as long as carbon nanotubes can connect the both electrodes, and electrically connect them, the part connecting to carbon nanotubes of 100 μm or less, for examples 50 μm or less is advantageous when the bolometer is applied to an image sensor by two-dimensionally arraying.

In the case of a networked film, for example, electrodes can be installed in such a manner that one circular film is connected to one electrode pair as in FIG. 10.

In the case of an aligned film, electrodes can be installed in such a manner that both of two circular arc-shape aligned films are connected to electrodes as in FIG. 10, or be installed in such a manner that either one of the circular arc-shape aligned films is connected to electrodes as in FIG. 11. Two circular arc-shape oriented films being connected allows a resistance to be reduced by approximately half and thus is advantageous for reduction in resistance; however, a length of the electrodes needs to be longer than a diameter of the APTES circles. On the other hand, one circular arc-shape aligned film, which is either one edge, being connected alone enables making the width of connection between the carbon nanotube and the electrodes, for example, 50 μm or less and thus is advantageous for element downsizing such as two-dimensional arraying.

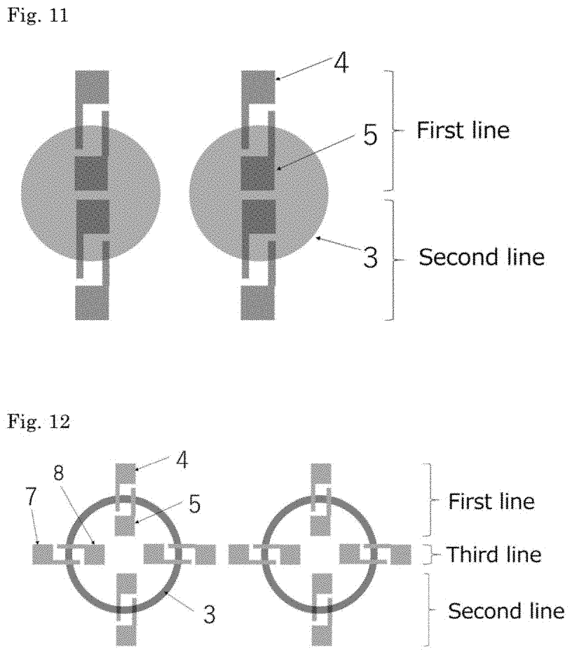

Also, in the case of an aligned film, for forming a more finer and denser array, as in FIG. 12, respective pairs of first and second electrodes (4 and 5) of a first electrode pair line and a second electrode pair line can be fabricated on two circular arcs facing in a diameter direction, and furthermore, pairs of third and fourth electrodes (7 and 8) of a third electrode pair line, which form a line in a direction approximately perpendicular to the electrode pairs of the first and the second electrode pair lines, can be fabricated on circular arc parts that are approximately 90° from the two circular arcs.

More specifically, in each of circles of circular shape aligned films of carbon nanotubes, the circles being arranged in a line, as illustrated in FIG. 12, two circular arc parts facing each other in a longitudinal diameter direction are used for the first line and the second line of the electrode pair lines, and furthermore, lateral circular arc parts located approximately 90° from the diameter direction are used for the third line of the electrode pair lines. In other words, the third electrode pair line is disposed in such a manner that the electrode pairs (7, 8) forming the electrode pair line are approximately perpendicular to the electrode pairs (4, 5) forming the first and second electrode pair lines.

Such bolometer electrodes can be manufactured by forming one line of circular shape APTES applied layers, dripping a carbon nanotube dispersion liquid on the circular shape APTES and gradually drying the dripped dispersion liquid, resulting in carbon nanotubes depositing in an aligned manner on edges of each of the APTES layers, and then disposing three lines of electrode pair line on the thus-formed one line of circular shape aligned films in such a manner that each circular shape aligned film approximately perpendicularly bridges the respective pairs of electrodes included in the respective electrode pair lines. Upon removal of unnecessary carbon nanotubes between the electrode pairs via, e.g., oxygen plasma, a bolometer comprising three electrode pair lines in which circular arc-shape aligned films cut out from carbon nanotube circular shape aligned films aligned in one line are connected in such a manner as to approximately perpendicularly bridge the respective pairs of electrodes is formed.

In this case, as illustrated in FIG. 12, four elements can be fabricated from one circular shape aligned film, enabling cost reduction and simplification.

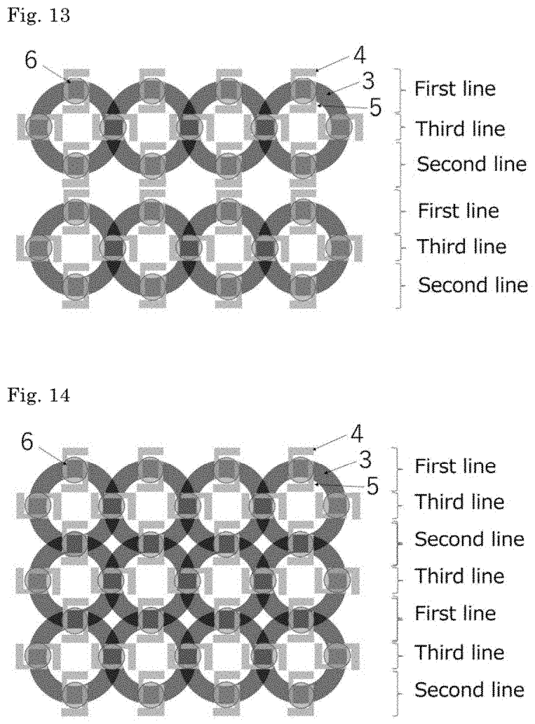

FIGS. 13 and 14 each illustrate a further example of arraying of the embodiment in which a third electrode line is fabricated. As indicated in these examples, an even finer and denser array may be provided by disposing electrode pairs on each of parts at which laterally arranged circular shape aligned films and/or longitudinally arranged circular shape aligned films overlap each other. As in the first embodiment, unnecessary carbon nanotubes are subjected to removal processing.

If the networked film or an aligned film of carbon nanotubes is only installed between electrodes of each of the electrode pairs, as shown in FIG. 10, no carbon nanotubes are present between adjacent electrode pairs, so a process of removing unnecessary carbon nanotubes is not needed. Heating at 200° C. in air can remove excess solvents, surfactants, and other substances.

When the networked film or an aligned film of carbon nanotubes are connected also to an adjacent electrode pair, as shown in FIGS. 11 to 16, for example, unnecessary carbon nanotubes are removed via the following method. An acrylic resin solution such as a polymethylmethacrylate resin (PMMA) is applied to regions each including an area between electrodes on the formed carbon nanotube film to form protective layers of PMMA. The substrate is heated at 200° C. in the atmosphere, extra solvent, impurities, etc., are removed and then the entire substrate is subjected to oxygen plasma treatment to remove extra carbon nanotubes, etc., present in regions, other than the regions of carbon nanotubes layer connecting each pair of the first electrode and the second electrode.

Also in the present embodiment, a protective layer may be provided on the surface of the carbon nanotube layer, if necessary. When the bolometer is used as an infrared sensor, the protective layer is preferably a material with high transparency in the infrared wavelength range to be detected, and acrylic resins such as PMMA, epoxy resins, Teflon (R) and the like may be used.

Although the above embodiment indicates a bolometer element manufacturing method having a sequence of forming an APTES layer on an Si substrate and forming a carbon nanotube layer and then forming electrodes, a manufacturing method in which the sequence is changed as follows may be employed. First, a first electrode and a second electrode are produced on a washed Si substrate via gold vapor deposition, and APTES is applied thereon. For the APTES application, parts other than the circular shape portions are masked, and then the substrate is immersed in an APTES aqueous solution or an APTES aqueous solution is sprayed onto the substrate and the substrate is dried. Subsequently, the masking is removed. The circular-shape APTES portions above may be applied using, e.g., a dispenser, an inkjet or a printer, and as necessary, washed with water and dried. Although the APTES layer is an insulating film, the APTES layer binds to a surface of a silicon dioxide film of the substrate and presents amino group on the surface, and thus, does not adhere to the gold electrode portions. A carbon nanotube dispersion liquid is dropped thereon left at rest, and then washed out using, e.g., alcohol or water and dried, and then, carbon nanotubes adhere to the entire APTES adhering portion in a networked manner. Or, when the dropped dispersion liquid is gradually dried, carbon nanotubes are deposited while being aligned on the edge of the APTES film. The opposite ends of the formed networked film or aligned film are directly connected to the electrodes. When no carbon nanotube connects between adjacent electrode pairs, as shown in FIG. 10, a process of removing unnecessary carbon nanotubes using PMMA and the like is not needed.

### Fifth Embodiment

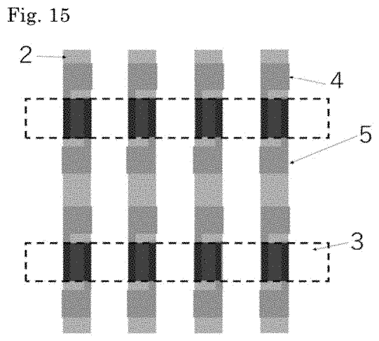

FIG. 15 illustrates a schematic plan view of an APTES layer 2 according to an embodiment of the present invention, the APTES layer 2 being fabricated in a line shape including positions at which a first electrode 4 and a second electrode 5 are to be formed, the line shape being approximately parallel to the electrodes. As in the first embodiment, parts, other than line-shape APTES portions 2 in FIG. 15, of a washed Si substrate, are masked, and then, the substrate is immersed in an APTES aqueous solution or an APTES aqueous solution is sprayed onto the substrate, and the substrate is washed with water and then dried. Subsequently, the masking is removed from the substrate. The line-shape APTES portions 2 may be subjected to application using, e.g., a dispenser, an inkjet or a printer and dried.

The width of the line shape is desirably 10 μm to 1 mm, preferably 20 μm to 500 μm, and more preferably 30 μm to 300 μm.

Upon a carbon nanotube dispersion liquid that is similar to that of the first embodiment being applied approximately perpendicularly to the APTES line shape and approximately perpendicularly to first electrodes 4 and second electrodes 5 in such a manner as to connect the electrodes as in FIG. 15 (that is, approximately in parallel with a direction in which electrical current flows) (dash-line parts 3 in FIG. 15), the parts in which the APTES is not applied repel the dispersion liquid, and the dispersion liquid remains only on the parts at which an APTES applied portion and a dispersion liquid applied portion overlap each other. This substrate is left at rest and then washed with, e.g., alcohol or water and dried, enabling fabrication of carbon nanotube films with carbon nanotubes adhering only to the parts at which an APTES applied portion and a dispersion liquid applied portion overlap each other, in a networked fashion (networked films).

Also, after application of the carbon nanotube dispersion liquid and as necessary, removal of the dispersion liquid adhering to the parts other than the overlapped parts as above, the dispersion liquid is gradually dried, and then, during the drying, carbon nanotubes are accumulated in an aligned manner on edges of the quadrangular shape parts of the dispersion liquid remained on the overlapped parts (aligned films). Also, depending on conditions such as a diameter and a length of the carbon nanotubes, a concentration of a surfactant and a drying speed, a carbon nanotube film having a low degree of alignment or in a networked state being little aligned can be formed in the vicinities of edges of the quadrangular shape parts. The below aligned film-related descriptions can appropriately be applied also to such film having a low degree of alignment.

A bolometer of the present embodiment can be manufactured by forming such a quadrangular shape networked film or a quadrangular shape aligned film (aligned film formed in the vicinity of each of edges of four sides) of semiconducting carbon nanotubes as above on a substrate and then disposing electrodes according to the shape of the carbon nanotube film formed. For example, as in FIG. 15, first electrodes and second electrodes are fabricated so as to overlap on the APTES lines via gold vapor deposition. Consequently, the first electrodes and the second electrodes are connected via the quadrangular shape networked films or aligned films formed. In the case of an aligned film, carbon nanotubes are deposited in an aligned manner on the edges of the four sides, and thus, the aligned film is fabricated in the shape of two sets of two parallel lines. When one set of aligned films of carbon nanotubes are overlapped with a first electrode and a second electrode, the other set is disposed approximately in parallel with a direction of electrical current flowing between the first electrode and the second electrode.

In the bolometer of the present embodiment, the distance between the first electrode and the second electrode is preferably 1 μm to 500 μm, and more preferably 10 μm to 300 μm. For miniaturization, it is more preferably 1 μm to 200 μm. When the distance between electrodes is 1 μm or more, a reduction in the nature of TCR can be suppressed, even in the case of containing a small amount of metallic carbon nanotubes. In addition, the distance between electrodes of 100 μm or less, for example, 50 μm or less is advantageous when the bolometer is applied to an image sensor by two-dimensionally arraying. The length of the first electrode 4 and the second electrode 5 is preferably short as long as carbon nanotubes can connect the both electrodes, and electrically connect them, and the part connecting to carbon nanotubes of 100 μm or less, for examples 50 μm or less is advantageous when the bolometer is applied to an image sensor by two-dimensionally arraying.

In the present embodiment, a networked film or an aligned film of carbon nanotubes is fabricated in the form of a quadrangular at the intersection position of the APTES line and the carbon nanotube line, and thus, the electrodes can be installed so that the carbon nanotubes connect only between the electrodes of each of the electrode pairs. In this case, no carbon nanotubes are present between adjacent electrode pairs, so a process of removing unnecessary carbon nanotubes is not needed. Heating at 200° C. in air can remove excess solvents, surfactants, and other substances.

Also in the present embodiment, a protective layer may be provided on the surface of the carbon nanotube layer, if necessary. When the bolometer is used as an infrared sensor, the protective layer is preferably a material with high transparency in the infrared wavelength range to be detected, and acrylic resins such as PMMA, epoxy resins, Teflon (R) and the like may be used.

Although the above embodiment indicates a bolometer element manufacturing method having a sequence of forming an APTES layer on an Si substrate and forming a carbon nanotube layer and then forming electrodes, a manufacturing method in which the sequence is changed as follows may be employed. First, a first electrode and a second electrode are produced on a washed Si substrate via gold vapor deposition, and APTES is applied thereon. For the APTES application, the substrate is masked such that APTES is provided in a line-shape comprising a region of the first electrode and the second electrode, and the APTES is not applied between the adjacent electrode pairs, and then the substrate is immersed in an APTES aqueous solution or an APTES aqueous solution is sprayed onto the substrate and the substrate is dried. Subsequently, the masking is removed. The line-shape APTES portion may be applied using, e.g., a dispenser, an inkjet or a printer, and as necessary, washed with water and dried. Although the APTES layer is an insulating film, the APTES layer binds to a surface of a silicon dioxide film of the substrate and presents amino group on the surface, and thus, does not adhere to the gold electrode portions. A carbon nanotube dispersion liquid is applied thereon in a line approximately perpendicular to the APTES line so as to bridge the first electrode and the second electrode, and the substrate is left at rest, washed out using, e.g., alcohol or water and dried, and then, carbon nanotubes adhere to the quadrangular shape portions at which the APTES line and the carbon nanotube line overlap in a networked manner. Or, when the dropped dispersion liquid is gradually dried, carbon nanotubes are deposited in an aligned manner on the edge of the quadrangular shape portions at which the APTES line and the carbon nanotube line overlap. The opposite ends of the formed networked film or the aligned film are directly connected to the electrodes. Since no carbon nanotube connects between adjacent electrode pairs, a process of removing unnecessary carbon nanotubes using PMMA and the like is not needed.

### Sixth Embodiment

A bolometer according to the present embodiment has a structure that is similar to that in FIG. 1 but uses a plastic substrate instead of an Si substrate 1. Also, polylysine is used instead of an APTES layer 2. Polylysine easily binds to a surface of a plastic substrate, and, like APTES, presents amino group on a surface, and thus, a polylysine film does not repel a carbon nanotube dispersion liquid and easily pins droplets of dispersion liquid. For a polylysine film application method and a bolometer manufacturing method, steps that are similar to the steps described in the first to fifth embodiments can be used. The present embodiment enables employment of a flexible substrate and thus can be used for, e.g., a flexible image sensor.

The whole or part of the example embodiments disclosed above can be described as, but not limited to, the following supplementary notes.
[Supplementary Note 1]

A bolometer manufacturing method comprising

forming an interlayer having a function that enhances binding between a substrate and a semiconducting carbon nanotube, in a predetermined pattern shape on the substrate, and

providing a droplet of a semiconducting carbon nanotube dispersion liquid on the formed interlayer.
[Supplementary Note 2]

The bolometer manufacturing method according to supplementary note 1, comprising fabricating the interlayer in a line shape, a quadrangular shape or a circular shape.
[Supplementary Note 3]

The bolometer manufacturing method according to supplementary note 1 or 2, comprising, after providing the droplet of the semiconducting carbon nanotube dispersion liquid on the interlayer fabricated on the substrate, leaving the substrate at rest, and then washing the droplet out and drying the substrate.
[Supplementary Note 4]

The bolometer manufacturing method according to supplementary note 1 or 2, comprising, after providing the droplet of the semiconducting carbon nanotube dispersion liquid on the interlayer fabricated on the substrate, drying the droplet on an edge of the shape of the interlayer.
[Supplementary Note 5]

The bolometer manufacturing method according to supplementary note 2, wherein a width of the line shape is 10 μm to 1 cm.
[Supplementary Note 6]

The bolometer manufacturing method according to supplementary note 2, wherein a size of the quadrangular shape is such that a length of a side that is approximately parallel to an electrode is 10 μm to 1 cm and a length of a side that is approximately perpendicular to the electrode is 10 μm to 1 mm.
[Supplementary Note 7]

The bolometer manufacturing method according to supplementary note 2, wherein a size of the circular shape is such that a diameter is 10 μm to 1 cm.
[Supplementary Note 8]

The bolometer manufacturing method according to supplementary note 4, wherein a thickness of a carbon nanotube deposited within 10 μm from the edge of the shape of the interlayer is 30 nm or more and 1 μm or less.
[Supplementary Note 9]

The bolometer manufacturing method according to any one of supplementary notes 1 to 4, wherein the droplet of the carbon nanotube dispersion liquid is provided in such a manner as to form a line shape approximately perpendicular to the interlayer formed in a line shape.
[Supplementary Note 10]

The bolometer manufacturing method according to any one of supplementary notes 1 to 9, wherein the interlayer is a silane coupling agent layer or a cation polymer layer.
[Supplementary Note 11]

The bolometer manufacturing method according to any one of supplementary notes 1 to 10, wherein the semiconducting carbon nanotube dispersion liquid comprises 90% by mass or more of the semiconducting carbon nanotube in a total amount of carbon nanotube.
[Supplementary Note 12]

The bolometer manufacturing method according to any one of supplementary notes 1 to 11, wherein the semiconducting carbon nanotube dispersion liquid comprises a critical micellar concentration or more and 5% by mass or less of a non-ionic surfactant.
[Supplementary Note 13]

The bolometer manufacturing method according to any one of supplementary notes 1 to 12, wherein the substrate is an Si substrate and the interlayer is a silane coupling agent layer.
[Supplementary Note 14]

The bolometer manufacturing method according to any one of supplementary notes 1 to 12, wherein the substrate is a plastic substrate and the interlayer is a cation polymer layer.
[Supplementary Note 15]

The bolometer manufacturing method according to any one of supplementary notes 1 to 12, wherein the interlayer is an amino silane compound layer or a cation polymer layer including amino group.
[Supplementary Note 16]

The bolometer manufacturing method according to supplementary note 15, wherein the interlayer is a layer of 3-aminopropyltriethoxysilane (APTES) or polylysine.
[Supplementary Note 17]

The bolometer manufacturing method according to any one of supplementary notes 1 to 16, wherein the droplet of the semiconducting carbon nanotube dispersion liquid is formed on the interlayer by the semiconducting carbon nanotube dispersion liquid being provided on the interlayer via a dripping method, inkjet, spray coating or a dip coating method.
[Supplementary Note 18]

The bolometer manufacturing method according to any one of supplementary notes 1 to 17, wherein the bolometer is an infrared sensor.
[Supplementary Note 19]

The bolometer manufacturing method according to any one of supplementary notes 1 to 18, wherein the bolometer is a bolometer array.

### EXAMPLES

The present invention will be described further in detail by way of examples below, but the present invention should not be limited by the following examples.

### Example 1

100 mg of single-walled carbon nanotubes (Meijo Nano Carbon Co., Ltd., EC 1.0 (diameter: about 1.1 to 1.5 nm (average diameter 1.2 nm)) was put in a quartz boat and heat treatment was performed under a vacuum atmosphere using an electric furnace. The heat treatment was performed at a temperature of 900° C. for 2 hours. The weight after heat treatment was reduced to 80 mg, and it was found that the surface functional groups and impurities were removed. After the obtained single-walled carbon nanotubes were fractured with tweezers, 12 mg of which was immersed in 40 ml of an aqueous solution of 1 wt % surfactant (polyoxyethylene (100) stearyl ether) and after sufficient sedimentation, the mixture was subjected to ultrasonic dispersion treatment (BRANSON ADVANCED-DIGITAL SONIFIER apparatus, output: 50 W) for 3 hours. Through this step, aggregates of the carbon nanotubes in the solution were eliminated. Through this procedure, bundles, remaining catalysts, and the like were removed to obtain a carbon nanotube dispersion liquid. The dispersion liquid was applied on a SiO₂ substrate and dried at 100° C., which was then observed by an atomic force microscope (AFM) to observe the length and the diameter of carbon nanotubes. As a result, it was found that 70% of the single-walled carbon nanotubes had a length within a range of 500 nm to 1.5 μm and the average length thereof was approximately 800 nm.

The above obtained carbon nanotube dispersion liquid was introduced into the separation apparatus having a double tube structure. About 15 ml of water, about 70 ml of the carbon nanotube dispersion liquid, and about 10 ml of 2 wt % aqueous surfactant solution were put into the outer tube of the double tube, and about 20 ml of 2 wt % aqueous surfactant solution was also put into the inner tube. Thereafter, the bottom lid of the inner tube was opened, resulting in a three-layer structure having different surfactant concentrations. A voltage of 120 V was applied with the bottom side of the inner tube being anode, and the upper side of the outer tube being cathode, and semiconducting carbon nanotubes were transferred towards the anode side. On the other hand, metallic carbon nanotubes were transferred towards the cathode side. After 80 hours from the start of separation, semiconducting carbon nanotubes and metallic carbon nanotubes were separated cleanly. The separation step was carried out at room temperature (about 25° C.). The semiconducting carbon nanotube dispersion liquid transferred to the anode side was collected and analyzed using the light absorption spectrum, and it was found that the metallic carbon nanotubes components were removed. It was also found from the Raman spectrum that 99 wt % of the carbon nanotubes in the carbon nanotube dispersion liquid transferred to the anode side were semiconducting carbon nanotubes. The most frequent diameter of the single-walled carbon nanotubes was about 1.2 nm (70% or more), and the average diameter was 1.2 nm.

The surfactant was partially removed from the carbon nanotube dispersion liquid containing 99 wt % semiconducting carbon nanotubes as described above (the carbon nanotube dispersion liquid transferred to the anode side) to adjust the concentration of the surfactant to be 0.05 wt %. Thereafter, the carbon nanotube dispersion liquid was adjusted into a carbon nanotube dispersion liquid A having a carbon nanotube concentration in the dispersion liquid of 0.01 wt % (referred to as dispersion liquid A). This dispersion liquid A was used to form a carbon nanotube layer.

An Si substrate coated with SiO₂ was sequentially washed with acetone, isopropyl alcohol and water and subjected to oxygen plasma treatment to remove organic substances on a surface. As in FIG. 2A (upper diagram), parts, other than the line-shape APTES portions having a width of approximately 300 μm, of the substrate were masked by a kapton tape, and then, the substrate was immersed in a 0.1% by volume APTES aqueous solution for 30 minutes and washed with water, and then the kapton tape was removed from the substrate and the substrate was dried.

Upon approximately 10 μL of the dispersion liquid A being dripped onto the line-shape APTES adhering portions, the parts to which no APTES adhered (masked parts) repelled the dispersion liquid and the dispersion liquid A rested only on the APTES adhering portions. The dispersion liquid A was gradually dried at room temperature (approximately 25° C.), atmospheric pressure and a humidity of 60% RH. The substrate was washed with water, ethanol and isopropyl alcohol and then dried at 110° C. and subsequently heated at 200° C. in the atmosphere to remove a non-ionic surfactant, etc., in the dispersion liquid A. An SEM observation of edges of the APTES line shape showed that carbon nanotubes deposited in a line shape on each of the edges, with a width of approximately 10 μm from the edge, and as in the SEM image in FIG. 4, carbon nanotubes accumulated with a high degree of alignment. The SEM image was subjected to two-dimensional Fourier transform processing to calculate an integrated value f of amplitudes of frequencies of −1 μm⁻¹ to +1 μm⁻¹ in one direction from a center, and where fx is an integrated value relating to a direction x in which the integrated value f becomes maximum and fy is an integrated value relating to a direction y perpendicular to the direction x, fx/fy was calculated to be 2.1. A thickness of the carbon nanotube layer was measured using a laser microscope and the thickness was approximately 100 nm in average (average value of 10 points) at 10 μm from an edge.

Gold was vapor-deposited on each of the carbon nanotube aligned films obtained above as a first electrode and a second electrode in such a manner as to have a thickness of 300 nm and provide a space of 100 μm between the electrodes, to fabricate the electrodes. At this time, the electrodes were installed in such a manner that edge lines of the APTES, that is, an alignment direction of the aligned carbon nanotubes, and a direction in which electrical current flows between the electrodes were approximately parallel to each other. Next, regions including carbon nanotubes, and parts of connection between the first electrode and the second electrode and the carbon nanotubes were protected by application of a PMMA anisole solution. Subsequently, the substrate was dried for one hour under a condition of 200° C. in the atmosphere and unnecessary carbon nanotubes connecting adjacent electrode pairs were removed via oxygen plasma treatment.

### Example 2

A carbon nanotube dispersion liquid A was prepared as in the steps of Example 1. After an Si substrate being washed as in Example 1, as in FIG. 7, parts other than quadrangular APTES portions of approximately 300 μm×approximately 300 μm, of the substrate were masked with a kapton tape, and then, the substrate was immersed for 30 minutes in a 0.1% by volume APTES aqueous solution and washed with water, and then, the kapton tape was removed from the substrate and the substrate was dried.

Upon approximately 1 μL of the above dispersion liquid A being dripped onto the quadrangular APTES adhering portions, the parts to which no APTES adhered (masked parts) repelled the dispersion liquid and the dispersion liquid A rested only on the APTES adhering portions. The substrate was left at rest for approximately 30 minutes and washed with water, ethanol and isopropyl alcohol, and then was dried at 110° C. and subsequently heated at 200° C. in the atmosphere to remove a non-ionic surfactant, etc. An SEM observation of the APTES line shape part showed that carbon nanotubes adhered in a random network form. A thickness of the carbon nanotube layer was measured using a laser microscope and the thickness was approximately 20 nm in average (average value of 10 points) at 10 μm from an edge.

Gold was vapor-deposited on each of the networked carbon nanotube films obtained above as a first electrode and a second electrode in such a manner as to have a thickness of 300 nm and provide a space of 100 μm between the electrodes, to fabricate the electrodes. At this time, the electrodes were installed in such a manner that one side of the APTES and a direction in which electrical current flows between the electrodes were approximately parallel to each other. Next, regions each including carbon nanotubes, and parts of connection between a first electrode and a second electrode and the carbon nanotubes were protected by application of a PMMA anisole solution. Subsequently, the substrate was dried for one hour under a condition of 200° C. in the atmosphere.

### Comparative Example 1

A carbon nanotube dispersion liquid A was prepared as in the steps of Example 1. After an Si substrate being washed as in Example 1, APTES was made to adhere to an entire surface of the substrate without the substrate being masked. Upon the dispersion liquid A being dripped onto the substrate, the dispersion liquid A spread to the entire surface of the substrate. The substrate was washed with water, ethanol and isopropyl alcohol and then dried at 110° C. and subsequently heated at 200° C. in the atmosphere to remove a non-ionic surfactant, etc. An SEM observation of the substrate showed that the carbon nanotubes adhered to the substrate in a random network form. A thickness of the carbon nanotube layer was measured using a laser microscope and the thickness was approximately 10 nm in average.

Thereafter, gold was vapor-deposited on the carbon nanotube layer above as a first electrode and a second electrode in such a manner as to have a thickness of 300 nm and provide a space of 100 μm between the electrodes. Carbon nanotubes, and the first electrode and the second electrode were protected with PMMA with the same area as in Example 1, dried for one hour under a condition of 200° C. in the atmosphere, and unnecessary carbon nanotubes were removed via oxygen plasma treatment.

Table 1 indicates a result of film resistance measurement at 300 K, a resistance variation of 10 samples fabricated in a similar manner, and a TCR value in a range of 20° C. to 40° C. for each of bolometers fabricated from respective carbon nanotube films obtained in Examples 1 and 2 and Comparative Example 1.

### Comparison Between Example 1 and Comparative Example 1

It turned out that the aligned carbon nanotube film in Example 1 had a film resistance two digits lower than that of Comparative Example 1, and had small resistance variation among the samples. This is because in Example 1, areas of points of contact between electrical conduction paths of carbon nanotubes increased because of alignment of the carbon nanotubes. Also, the bolometer of Example 1 had a TCR value that is larger than that of the bolometer of Comparative Example 1. This is presumably because change in resistance according to temperature was stably measured because of stable electrical conduction paths resulting from the large decrease in resistance value.

### Comparison Between Example 2 and Comparative Example 1

It turned out that in comparison with Comparative Example 1, the carbon nanotube film of Example 2, which was fabricated by patterning an APTES layer, had a film resistance one digit lower than that of Comparative Example 1, and small resistance variation among the samples. This is because in Example 2, the carbon nanotubes formed a high-density network and points of contact between electrical conduction paths of the carbon nanotubes increased. Also, it is presumable that, by conducting patterning, variation in film condition among the samples was decreased by a networked film that is more uniform than that of Comparative Example 1.

TABLE 1
Measurement Results of Resistance and TCR

| | | | Comparative |
|---|---|---|---|
| | Example 1 | Example 2 | Example 1 |
| Film Resistance (Ω) | 5 × 10⁷ | 6 × 10⁸ | 1 × 10⁹ |
| Standard deviation of | 65% | 70% | >100% |
| membrane resistance (%) | | | |
| TCR (%/K) | −6.2 | −6.0 | −5.2 |

### EXPLANATION OF REFERENCE

1 Si substrate
2 APTES layer
3 Carbon nanotube layer
4 First electrode
5 Second electrode
6 PMMA layer
7 Third electrode
8 Fourth electrode
a Width of line-shape APTES adhering portion
2a, 2a′ Edges of line-shape APTES adhering portion
b, c Width of quadrangular-shape APTES adhering portion
2b, 2b′ Edges of quadrangular-shape APTES adhering portion
2c, 2c′ Edges of quadrangular-shape APTES adhering portion

What is claimed is:

1. A bolometer manufacturing method comprising
forming an interlayer having a function that enhances binding between a substrate and a semiconducting carbon nanotube, in a predetermined pattern shape on the substrate, and
providing a droplet of a semiconducting carbon nanotube dispersion liquid on the formed interlayer.

2. The bolometer manufacturing method according to claim 1, comprising fabricating the interlayer in a line shape, a quadrangular shape or a circular shape.

3. The bolometer manufacturing method according to claim 1, comprising, after providing the droplet of the semiconducting carbon nanotube dispersion liquid on the interlayer fabricated on the substrate, leaving the substrate at rest, and then washing the droplet out and drying the substrate.

4. The bolometer manufacturing method according to claim 1, comprising, after providing the droplet of a semiconducting carbon nanotube dispersion liquid on the interlayer fabricated on the substrate, drying the droplet on an edge of the shape of the interlayer.

5. The bolometer manufacturing method according to claim 2, wherein a width of the line shape is 10 μm to 1 cm.

6. The bolometer manufacturing method according to claim 2, wherein a size of the quadrangular shape is such that a length of a side that is approximately parallel to an electrode is 10 μm to 1 cm and a length of a side that is approximately perpendicular to the electrode is 10 μm to 1 mm.

7. The bolometer manufacturing method according to claim 2, wherein a size of the circular shape is such that a diameter is 10 μm to 1 cm.

8. The bolometer manufacturing method according to claim 4, wherein a thickness of a carbon nanotube deposited within 10 μm from the edge of the shape of the interlayer is 30 nm or more and 1 μm or less.

9. The bolometer manufacturing method according to claim 1, wherein the interlayer is a silane coupling agent layer or a cation polymer layer.

10. The bolometer manufacturing method according to claim 1, wherein the semiconducting carbon nanotube dispersion liquid comprises 90% by mass or more of the semiconducting carbon nanotube in a total amount of carbon nanotube.
